(19) United States
(12) Patent Application Publication
(10) Pub. No.: US 2016/0192667 A1
(43) Pub. Date: Jul. 7, 2016

(54) METHOD OF THAWING FROZEN FOOD

(71) Applicant: TOHOKU UNIVERSITY, Sendai-shi, Miyagi (JP)

(72) Inventors: Minoru SATO, Kurokawa-gun (JP); Toshiyasu YAMAGUCHI, Sendai-shi (JP); Toshiki NAKANO, Sendai-shi (JP)

(73) Assignee: TOHOKU UNIVERSITY, Sendai-shi, Miyagi (JP)

(21) Appl. No.: 14/908,726

(22) PCT Filed: Jul. 28, 2014
(86) PCT No.: PCT/JP2014/069802

§ 371 Date: Jan. 29, 2016

(30) Foreign Application Priority Data
Jul. 29, 2013 (JP) 2013-156542

(51) Int. Cl. A23B 4/07; A23B 5/045

(52) U.S. Cl. CPC A23B 4/07; A23B 5/045; A23V 2002/00

(57) ABSTRACT

There is provided a method of thawing a frozen food in which the frozen food can be rapidly and uniformly thawed without the degradation of its quality. A frozen food is thawed by the application of electromagnetic waves of 100 MHz±10 MHz to the frozen food. The frozen food is fish eggs such as frozen sea urchin or salmon roe, a marine product such as fish meat or whale meat, frozen minced fish meat, meat or mince thereof, or food such as sushi that is formed with different food ingredients.

### TECHNICAL FIELD

The present invention relates to a method of thawing frozen food.

### BACKGROUND ART

Freezing technology is originally a technology that allows long-term storage while maintaining the freshness and quality of agricultural and marine products and processed foods. Therefore, thawing technology aimed at utilizing agricultural and marine products and processed foods that are frozen for storage while maintaining the freshness and quality of these products at the time of freezing has so far been developed to substantially accompany freezing technology. Although various methods for freezing technology are proposed and are commercially available, no innovative methods for thawing technology are available for homes and businesses. Examples of methods of thawing frozen products include classic thawing methods (which are classified as an “external heating method” because ambient heat is utilized) such as a room temperature or refrigerator natural thawing method and a running water thawing method and an electromagnetic wave thawing method (which is classified as an “internal heating method” because heating is performed from the inside of an item to be thawed) utilizing high-frequency waves of around 13 MHz and microwaves of around 2.5 GHz. Non Patent Literature 1 discloses that requirements for thawing methods are as follows: (1) uniform thawing is achieved, (2) the final thawing temperature is not high, (3) the temperature is increased to the final thawing temperature in a short period of time, (4) a small amount of drip loss at the time of thawing is achieved, (5) drying during thawing is kept to a small amount, (6) contamination during thawing is kept to a small amount, (7) discoloration is prevented, and the like, and in order to achieve these purposes, the electromagnetic wave thawing method is suitable.

Non Patent Literature 1 discloses that as electromagnetic waves used for thawing, in a high-frequency band, electromagnetic waves (around 13 MHz) of 11 to 40 MHz are used, and in a microwave band, electromagnetic waves (around 2.45 GHz) of 915 or 2,450 MHz are used. As problems produced when electromagnetic waves are used for thawing, for example electromagnetic waves around 13 MHz, thawing is affected by the shape of a target such as its size and its thickness and the component composition, such as moisture, and a “burnt part” is formed by discharge produced by application performed between close electrodes. For example, at around 2.45 GHz, a “cooked” surface and non-uniform thawing are produced by the low permeability of electromagnetic waves. At present, the thawing method using electromagnetic waves cannot provide a state of thawing that satisfies all freshness and quality conditions required of frozen products after thawing.

As specific examples of problems with the conventional thawing method utilizing electromagnetic waves, at around 2.45 GHz, a “cooked part” or a non-uniform thawing state is produced by partial overheating resulting from the low permeability of electromagnetic waves on the target. Disadvantageously, at around 13 MHz, it takes a long period of time to perform thawing processing, and the reached thawing temperature is low (within the maximum ice crystal generation zone below freezing). Thus, in the subsequent complete thawing, degradations of quality are caused in which a large amount of drip (a colored liquid that is produced from fish and fish fillets and that contains blood components) is produced from fish and fish fillets and discoloration occurs in the fillet. On the other hand, in fish eggs such as sea urchin (sea urchin gonads), salmon roe and herring roe, as compared with fish meat, the cooked state and quality of tissue breakdown caused by overheating with microwaves are remarkable, and it is considered at present that no appropriate thawing method for fish eggs exists, with the result that technological developments for solving such problems are required.

As solutions to these problems, various techniques are proposed. For example, in Patent Literature 1, a method in which a device that reads a high-frequency output produced when electromagnetic waves of 10 to 100 MHz are applied to a target and that adjusts the output to maintain it at an appropriate level is incorporated to prevent partial overheating (cooked state) on the target is adopted. As a background for this method, it is assumed that permeability to the target is degraded depending on the frequency to cause overheating only in the surface, and it can be said that this equipment is not necessary depending on the frequency used. In Patent Literature 2, electromagnetic waves of 2.45 GHz are used to heat a stand on which the target to be thawed is placed, and thus the target to be thawed is indirectly thawed. Specifically, this is intended for thawing frozen hand-rolled sushi but it is not widely used at all. In Patent Literature 3, a thawing method is formed with two steps, that is, in the first stage (dielectric heating step), electromagnetic waves of 1 to 100 MHz are applied to the target, and in the second stage (external heating step) following the first stage, a mist or jet shower is applied to the target to heat it externally, with the result that a complicated and large device is needed. In Patent Literature 4, a method of thawing the target to be thawed by applying electromagnetic waves of 10 to 300 MHz to the target which is frozen by being coated or mixed with a cryoprotectant such as sucrose is adopted, but it can be said that it is impossible to use it for thawing marine products for which fresh and delicate tastes are required.

### CITATION LIST

### Patent Literature

Patent Literature 1: Japanese Unexamined Patent Application Publication No. 57-68775
Patent Literature 2: Japanese Unexamined Patent Application Publication No. 11-251054
Patent Literature 3: Japanese Unexamined Patent Application Publication No. 2000-262263
Patent Literature 4: Japanese Unexamined Patent Application Publication No. 2002-272436

### Non Patent Literature

Non Patent Literature 1: Hideo TSUYUKI, Commercial High-frequency Thawing Machine And Microwave Thawing Machine, Cold Chain, 3 (1), 2-15 (1977)

### SUMMARY OF INVENTION

### Technical Problem

Since ancient times, the culture of a raw diet featuring marine products has been widely ingrained in the people of Japan, and a raw diet including sliced raw fish and sushi is now widely accepted. This has affected the formation of food culture in which consumers evaluate thawed products with substantially the same strict criteria as fresh marine products and fresh processed marine products before purchasing and eating them. Hence, in the fishing industry and fishing processing industry, the use of conventional thawing methods which can cause quality degradation such as food poisoning and overheating associated with a large amount of drip, discoloration and microbial contamination is a serious problem that is directly connected with a reduction in business performance and that needs to be solved. Therefore, the development of a more superior thawing technology is anticipated.

The present invention is made in view of the foregoing problems, and an objective of the present invention is to provide a method of thawing a frozen food in which the frozen food can be rapidly and uniformly thawed without degradation of its quality.

### Solution to Problem

As one of the requirements for thawing, uniform heating is performed from the surface of a food to the interior thereof to rapidly perform thawing. In this respect, in the internal heating method using electromagnetic waves, depending on the frequency band, it is possible to perform uniform heating from the surface of the frozen food to the interior thereof, unlike classic external heating, and thus it is possible to perform rapid and uniform thawing. As a second requirement, at the time of thawing, the maximum ice crystal generation zone should rapidly pass. As a third requirement, sea urchin and fish eggs are thawed while their shapes and colors are maintained, although this has so far been impossible to do. As a result of thorough examination of available frequencies, the inventors of the present invention have achieved a technology that satisfies the three requirements described above; that is, making it possible to perform rapid and uniform thawing of various frozen marine products and meat by applying electromagnetic waves of around 100 MHz while maintaining the quality thereof, and also making it possible to perform rapid and uniform thawing of sea urchin and fish eggs even though no effective thawing method has so far been present. In the case of sea urchin, an innovative thawing method is achieved in which sea urchin can be thawed without the use of alum serving as a deformation prevention material while the shape and color thereof are maintained and in which long-term storage can be thereafter performed.

Specifically, a method of thawing a frozen food according to the present invention is characterized in that an electromagnetic wave of 100 MHz±10 MHz is applied to a frozen food so as to thaw the frozen food.

In the method of thawing a frozen food according to the present invention, in particular, it is possible to rapidly and uniformly thaw fish eggs such as frozen sea urchin and salmon roe and marine products such as fish meat and whale meat without degrading the quality thereof.

In the method of thawing a frozen food according to the present invention, in particular, it is possible to rapidly and uniformly thaw frozen minced fish meat, meat or mince thereof without degrading the quality thereof.

In the method of thawing a frozen food according to the present invention, in particular, it is possible to rapidly and uniformly thaw food such as sushi that is formed with different food ingredients without degrading the quality thereof.

### Advantageous Effects of Invention

Disadvantageously, in conventional classic thawing technology, it takes a long time to thaw frozen food and a drip occurs after the thawing. Although a method utilizing electromagnetic waves of 13.56 MHz is also present as a thawing method using electromagnetic waves, it takes a long time to perform the thawing, the reached thawing temperature is in the maximum ice crystal generation zone of around −2° C., significant tissue breakdown occurs, and the occurrence of a drip after thawing is remarkable, with the result that the utilization thereof is limited. By contrast, the present invention is a technology that can rapidly and uniformly thaw, while maintaining a high quality thereof, fish eggs such as sea urchin and salmon roe, marine products such as fish meat and whale meat, minced fish meat, meat and mince thereof, and food such as sushi that is formed with different food ingredients which are difficult to thaw even with electromagnetic waves of 13.56 MHz, and is an invention that will produce significant ripple effects both in industries and in homes.

As described above, in the present invention, it is possible to provide a method of thawing a frozen food rapidly and uniformly without degrading the quality thereof.

### BRIEF DESCRIPTION OF DRAWINGS

FIG. 1 A block diagram showing a configuration conception of a thawing device used in a method of thawing a frozen food in an embodiment of the present invention;

FIG. 2 A front view of a prototype of the thawing device produced based on the configuration shown in FIG. 1;

FIG. 3 A graph showing, when a fillet (weight of about 80 g, thickness of about 2 cm and storage at −80° C.) of frozen tuna (bigeye tuna) was used as a sample and thawing processing was performed using frequencies of 2.45 GHz, 13.56 MHz and 100 MHz (with the thawing device shown in FIG. 2), a relationship between a time for thawing the tuna fillet and the temperature at the center thereof;

FIG. 4 A graph showing, when (a) a tuna fillet thawed within a commercially available household refrigerator and (b) tuna thawed with the thawing device shown in FIG. 2 were stored in the commercially available household refrigerator, the proceeding of the metmyoglobin of the tuna fillet based on the storage period;

FIG. 5 A diagram showing (a) a state where frozen salmon roe (stored at −80° C.) is frozen and (b) a state where electromagnetic waves of 100 MHz at 1000 W were applied to the frozen salmon roe for 20 seconds to thaw the frozen salmon roe;

FIG. 6 A diagram showing (a) a state where sea urchin frozen and stored at −80° C. without the use of alum was thawed with the 100 MHz electromagnetic waves (100 to 400 W, applied for 1 to 4 minutes), (b) a state where sea urchin was thawed at room temperature (28° C.), (c) a state where the sea urchin frozen and stored at −80° C. with the use of alum was thawed with the 100 MHz electromagnetic waves (100 to 400 W, applied for 1 to 4 minutes) and (d) a state where sea urchin was thawed at room temperature (28° C.);

FIG. 7 A diagram showing (a) a state where sea urchin frozen and stored at −80° C. without the use of alum was thawed with the 100 MHz electromagnetic waves (100 to 400 W, applied for 1 to 4 minutes) and was stored on ice for 20 hours after the thawing and (b) a state where sea urchin frozen and stored at −80° C. with the use of alum was thawed at room temperature (28° C.) and was stored on ice for 20 hours after the thawing;

FIG. 8 A diagram showing (a) a state where frozen tuna hand-rolled sushi (stored at −80° C.) was frozen and (b) a state where the frozen tuna hand-rolled sushi was thawed with the 100 MHz electromagnetic waves (200 W, applied for 4 minutes);

FIG. 9 A diagram showing a state where frozen yellowtail packed in a vacuum laminate (stored at −80° C.) was thawed with the 100 MHz electromagnetic waves (100 to 400 W, applied for 1 to 4 minutes);

FIG. 10 A graph showing variations in the temperature of whale meat being thawed (a) when the frozen whale meat was naturally thawed within a refrigerator and (b) when the frozen whale meat was thawed by the application of electromagnetic waves;

FIG. 11 A graph showing a drip ratio after the thawing when the frozen whale meat was naturally thawed within the refrigerator and when the frozen whale meat was thawed by the application of electromagnetic waves; and

FIG. 12 A diagram showing a state of the whale meat after the thawing (a) when the frozen whale meat was naturally thawed within the refrigerator and (b) when the frozen whale meat was thawed by the application of electromagnetic waves.

### DESCRIPTION OF EMBODIMENTS

An embodiment of the present invention is described below with reference to the drawings.

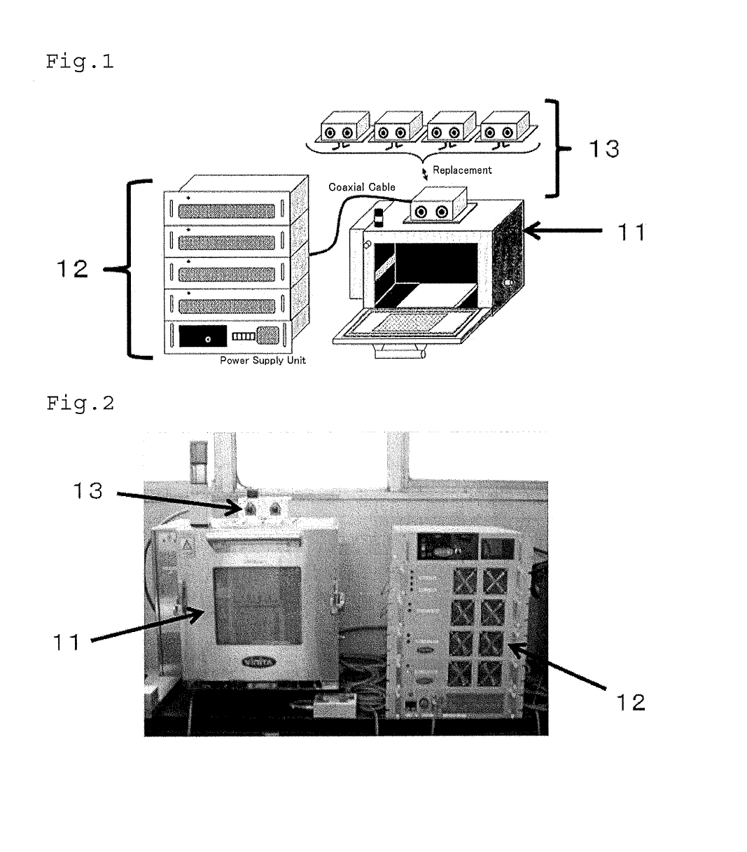

FIG. 1 is a block diagram of a thawing device of the present invention. The thawing device includes an application furnace member (cavity) 11, an amplifier (amp) 12 and a matching device (matching) 13. An antenna is provided within the application furnace member 11. The matching device 13 detects the intensity of applied electromagnetic waves and the intensity of reflected electromagnetic waves, and performs adjustment such that a difference between them is a practical output (wattage, W) which is an initially set value.

FIG. 2 is a prototype that is produced based on FIG. 1. The numbers in FIG. 2 correspond to those in FIG. 1.

### Example 1

A fillet (thickness of about 2 cm and weight of about 80 g) of frozen tuna (bigeye tuna) was used as a material, and thawing was performed using five frequencies of 2.45 GHz, 13.56 MHz, 162 MHz and 320 MHz, and the prototype (100 MHz) of FIG. 2 and a relationship between the thawing time and the temperature at the center of the tuna fillet is shown. The temperature at the center portion was measured with a bayonet-type metal thermometer. After the thawing, a 2 cm square block cut out of the center portion of the fillet was placed on filter paper, and the amount of drip was determined.

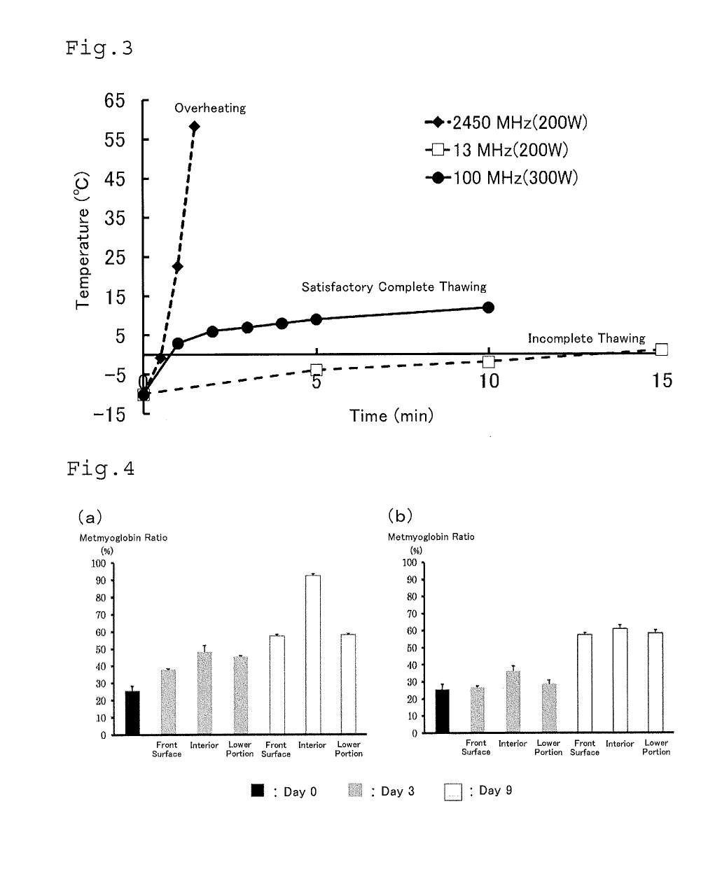

The results are shown in FIG. 3 and Table 1. Since the surface of the tuna was quickly cooked with the electromagnetic waves of 2.45 GHz, the thawing was performed by repeating an application of 30 seconds and a break of 30 seconds. The application time was obtained by the sum of practical application times. Even in this case, the surface of the tuna was cooked all over. Even when the electromagnetic waves of 13.56 MHz were applied for a long period of time, the center temperature did not reach a positive value, and one hour after the long-term application, thawing was performed by placement at room temperature (15° C.). Even when the electromagnetic waves of 100 MHz were applied continuously, a cooked surface was not recognized. The amount of drip was the largest in the 2.45 GHz electromagnetic wave thawing, was the second largest in the 13.56 MHz electromagnetic wave thawing and was the least in the 100 MHz electromagnetic wave thawing in which muscle tissue breakdown at the time of thawing was reduced and the quality retention effect was determined to be the largest. Since it appeared that a part of or the entire fillet was cooked with 162 MHz and 320 MHz, it was determined that they could not be used for thawing.

TABLE 1

| | | | Temperature at the | |
|---|---|---|---|---|
| Thawing | | Thawing | completion of | Amount of |
| frequency | | time | application (° C.) | drip (%) |
| 2.45 | GHz | Intermittent application | 15.2 | 4.2 |
| | | of 2 minutes | | |
| 13.56 | MHz | 60 minutes | −1.9 | 1.7 |
| 100 | MHz | 9 minutes | 3.4 | 0.5 |

### Example 2

As an effect obtained by a difference in the thawing method to the quality of fish meat after the thawing, a muscle pigment myoglobin metmyoglobin ratio was examined. When metmyoglobin proceeds, the muscle is discolored a yellowish brown, and thus its product value is lost. A fillet of tuna thawed within a commercially available household refrigerator and tuna thawed in the prototype of FIG. 2 were stored in the household refrigerator, and the metmyoglobin ratio was measured as time passed.

The results are shown in FIG. 4. Although on the first day, a significant difference in the metmyoglobin ratio between the tuna thawed within the household refrigerator and the tuna thawed by electromagnetic waves was not recognized, it was recognized that on the third day, metmyoglobin proceeded more both on the surface and in the interior of the tuna thawed within the household refrigerator than that of the tuna thawed by electromagnetic waves. With respect to this tendency, on the ninth day, in the tuna thawed within the household refrigerator, metmyoglobin proceeded almost to 100%, whereas in the tuna thawed by electromagnetic waves, both on the surface and in the interior, metmyoglobin proceeded to only 60%, with the result that the proceeding of metmyoglobin was reduced and a quality retention effect was recognized, as compared with the tuna thawed within the household refrigerator.

### Example 3

The state of thawing was examined when electromagnetic waves of 100 MHz were applied to frozen salmon roe at 1000 W.

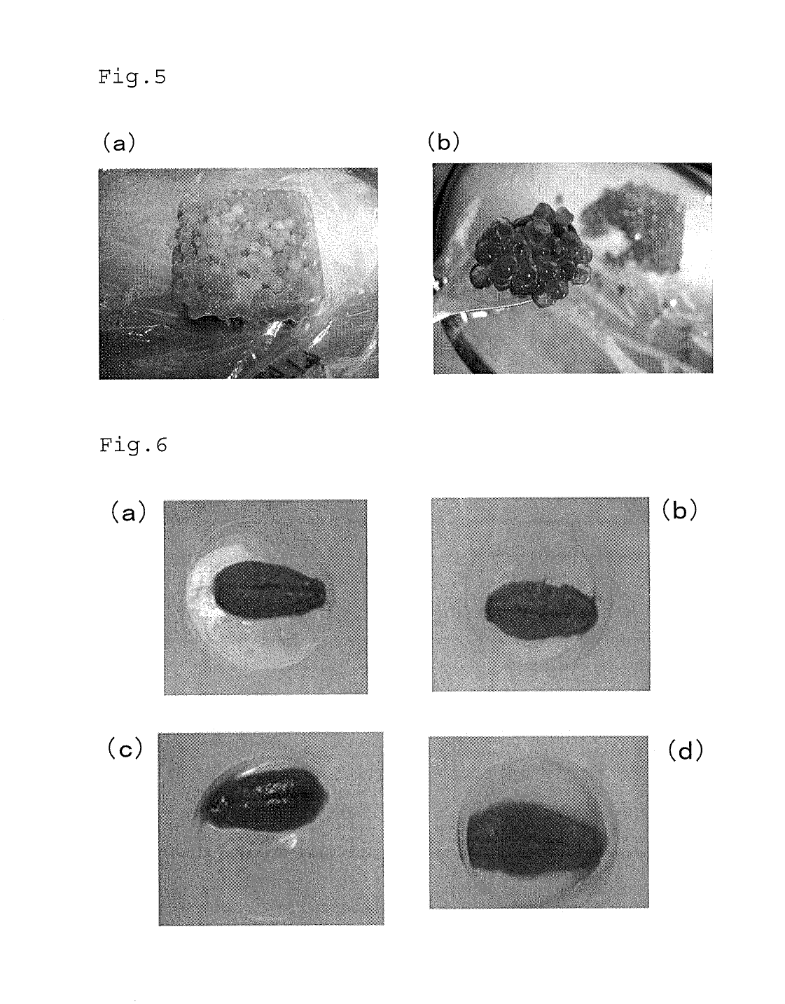

The results are shown in FIG. 5. Although the salmon roe was frozen at −80° C., it was thawed by an application of 20 seconds rapidly, uniformly and cleanly without being partially “cooked”. It is recognized again that it takes about 1 hour to completely thaw salmon roe at the same frozen temperature at room temperature (15° C.) and hence the speed of the electromagnetic wave thawing is remarkable. At frequencies other than 100 MHz, for example 162 MHz, 320 MHz and 2,450 MHz, cooked (whitened) salmon roe was often seen, with the result that it was determined that it was impossible to use them for thawing.

### Example 4

The thawing of frozen sea urchin and the change in quality of the sea urchin after thawing were compared between sea urchin thawed at room temperature and sea urchin thawed by the electromagnetic waves of 100 MHz. Raw sea urchin is easily self-digested, thus losing its shape, with the result that its product value is lost. Although raw sea urchin can be stored by being frozen, since, for example, its surface is dissolved at the time of thawing and thus loses its shape, the freezing of unprocessed raw sea urchin is not commercially practiced. Hence, at present, in order to maintain the shape of raw sea urchin, it is necessary to immerse it in alum. In order to also reduce intake of aluminum, it has been required to develop freezing/thawing technology without depending on alum. Because of these circumstances, the realization of thawing frozen sea urchin by electromagnetic waves of 100 MHz is anticipated. Here, on frozen sea urchin without the use of alum and frozen sea urchin with the use of alum, thawing by the electromagnetic waves of 100 MHz and thereafter the change in quality during storage were observed.

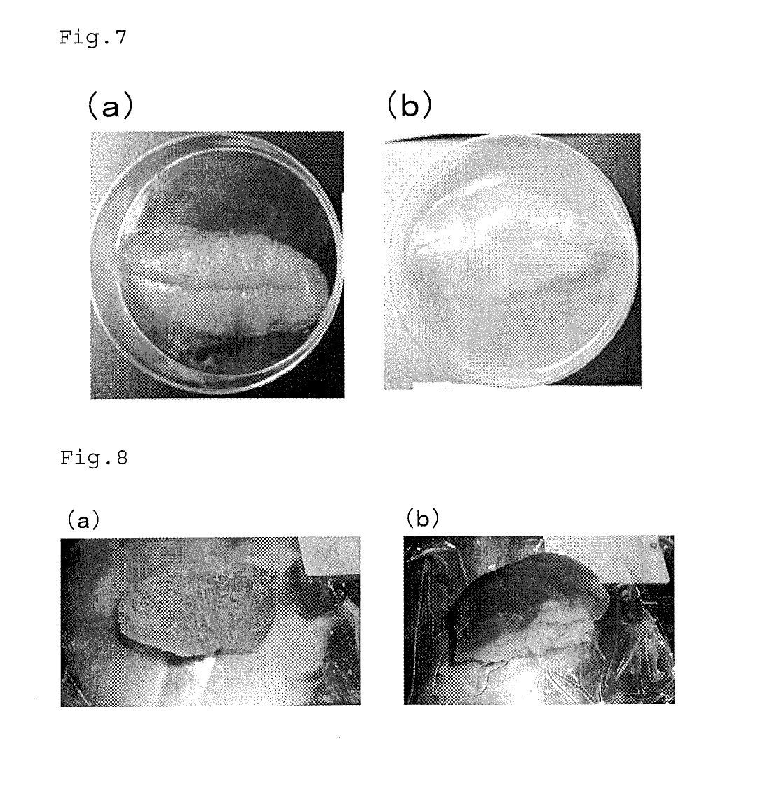

As the sea urchin without the use of alum and the sea urchin with the use of alum, commercially available ones were used and were frozen and stored at −80° C. As thawing methods, thawing at room temperature (28° C.) and thawing by the application of electromagnetic waves (100 to 400 W) of 100 MHz for 1 to 4 minutes were performed. The state of the sea urchin immediately after the thawing at room temperature and the thawing by the electromagnetic waves was shown in FIG. 6. Although the thawing at room temperature was completed after about 10 minutes, it was recognized that a small amount dripped on the surface during this process. The thawing by the electromagnetic waves at 100 W was completed after about 3 minutes. An abnormality in the appearance of the sea urchin was not recognized during this thawing. After the thawing, the sea urchin was stored at room temperature, in the refrigerator or on ice, and the occurrence of drip, a change in shape, and the like were observed. A part of the results is shown in FIG. 7. In the storage at room temperature, a large amount of drip was produced in about 30 minutes, and the collapse of the shape was remarkable. In the sea urchin with the use of alum stored on ice, liquefaction was remarkable after 20 minutes, and the shape had collapsed to the extent that the original shape could not be recognized. By contrast, in the sea urchin thawed by the electromagnetic waves, shape was maintained even without the use of alum, and almost no drip was recognized even after 20 hours, with the result that it was recognized to be a very satisfactory thawing technology. At frequencies other than 100 MHz, for example 162 MHz, 320 MHz and 2,450 MHz, the sea urchin was partially cooked and a rupture occurred, with the result that it was determined that it was impossible to use these frequencies for thawing.

### Example 5

Frozen sushi (hand-rolled tuna) that was frozen and stored at −80° C. was thawed. As thawing conditions, electromagnetic waves of 100 MHz at 100 to 400 W were applied to a target to be thawed for 1 to 4 minutes. The states before and after the thawing are shown in FIG. 8. By the electromagnetic wave thawing, a cooked state and overheating were prevented, and thus thawing was achieved. At frequencies other than 100 MHz, for example 162 MHz, 320 MHz and 2,450 MHz, part or the whole of the sushi ingredient was cooked.

### Example 6

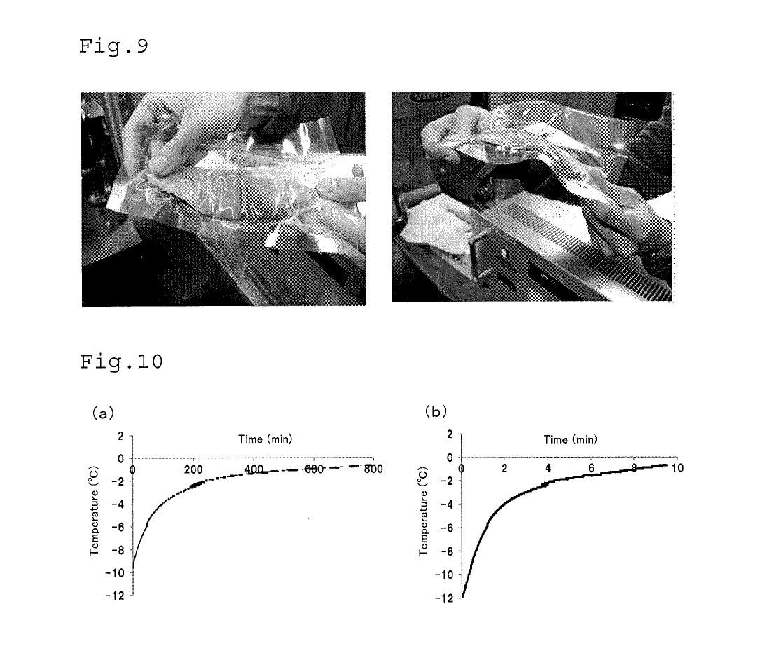

Frozen yellowtail that was packed and stored in a vacuum laminate at −80° was thawed. As thawing conditions, electromagnetic waves of 100 MHz at 100 to 400 W were applied to a target to be thawed for 1 to 4 minutes. The state after thawing is shown in FIG. 9. In the electromagnetic wave thawing, the color was not changed, a cooked state and drip were prevented from occurring, the interior thereof was satisfactorily thawed, and thus it became soft. With the vacuum packaging, it is possible to perform thawing sanitarily without contaminating hands.

### Example 7

Meat of a Bryde's whale (4×12×1.5 cm, about 85 g) that was frozen at −30° C. was thawed. In general, it is thought that in frozen whale meat rigidity (thawing rigidity) occurs at the time of thawing, a large amount of drip is produced and the quality is significantly lowered. For the thawing, natural thawing at room temperature (25° C.), natural thawing within a refrigerator (2° C.) and thawing by the application of the electromagnetic waves of 100 MHz were performed. The 100 MHz electromagnetic waves were applied with an electromagnetic wave application device (“FHSUT-1”) made by Yamamoto Vinita Co., Ltd. During the thawing, an optical fiber thermometer was inserted into the frozen whale meat to measure the temperature, and thawing was deemed complete when the temperature reached −2° C. After the completion of the thawing, the amount of drip from the whale meat and the amount of ATP (adenosine triphosphate) in the whale meat were measured. While the whale meat was being stored at 4° C., the change in myoglobin/metmyoglobin ratio per day was also measured.

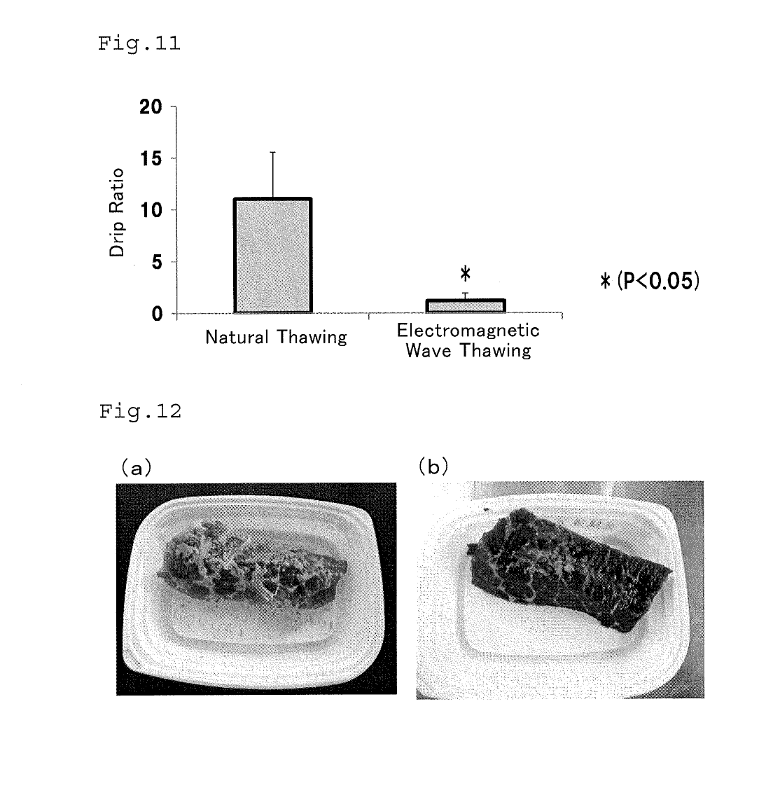

In the natural thawing within the refrigerator and the thawing by the electromagnetic wave application, the change in temperature of the whale meat being thawed is shown in FIG. 10, and a drip ratio after the thawing is shown in FIG. 11. In the natural thawing at room temperature, although the whale meat was thawed for about 1 hour, the meat was rigidified and a large amount of drip (drip occurrence ratio: about 30%) was produced. As shown in FIGS. 10(a) and 11, in the natural thawing within the refrigerator, although the whale meat was thawed for about 4 hours (240 minutes) and the drip ratio was lowered to about 11%, a large amount of drip was still produced, and the whale meat was rigid. In the thawing by the electromagnetic wave application, the whale meat was thawed for about 5 minutes, almost no drip was observed with a drip ratio of about 1%, and rigidity was prevented from occurring.

The state of the whale meat after the natural thawing within the refrigerator and the state of the whale meat after the thawing by the electromagnetic wave application are shown in FIG. 12. As shown in FIG. 12(a), the whale meat after the natural thawing within the refrigerator was rigidified and shrunk, and fat had floated to the surface. The texture was hard and was stiff. As shown in FIG. 12(b), in the whale meat after the thawing by the electromagnetic wave application, no rigidity was recognized and the surface was fresh. The texture was soft and juicy. Even in this state, ATP remained and the myoglobin/metmyoglobin ratio was lower than in the whale meat after the natural thawing within the refrigerator.

### INDUSTRIAL APPLICABILITY

The present invention is a technology that can rapidly and uniformly thaw frozen foods including fish eggs at a high quality and that can be utilized in various fields. The utilization of the rapid and uniform thawing method of the present invention allows the development of a new frozen food to be conceived. Specifically, the utilization backs up the practical realization of frozen sushi with various sushi items.

The application source of around 100 MHz used in the present invention is placed together with a presently widely used domestic microwave oven, and thus the freezing and thawing of food at home are actively utilized, with the result that it is expected that food education activities at home can be supported.

### REFERENCE SIGNS LIST

11 application furnace member (cavity)
12 amplifier (amp)
13 matching device (matching)

1. A method of thawing frozen sea urchin,
wherein an electromagnetic wave of 100 MHz±10 MHz is applied to frozen sea urchin so as to thaw the sea urchin.

2. (canceled)

3. (canceled)

4. A method of thawing frozen salmon roe,
wherein an electromagnetic wave of 100 MHz±10 MHz is applied to frozen salmon roe so as to thaw the salmon roe.

5. (canceled)

6. (canceled)

7. A method of thawing frozen sushi,
wherein an electromagnetic wave of 100 MHz±10 MHz is applied to frozen sushi so as to thaw the sushi.

8. A method of thawing frozen whale meat,
wherein an electromagnetic wave of 100 MHz±10 MHz is applied to frozen whale meat so as to thaw the whale meat.
